(19) United States
(12) Patent Application Publication
(10) Pub. No.: US 2002/0015480 A1
(43) Pub. Date: Feb. 7, 2002

(54) Flexible multi-network voice/data aggregation system architecture

(76) Inventors: Neil Daswani, Edison, NJ (US); Sin-Mei Tsai, San Francisco, CA (US); Jason Freund, Sunnyvale, CA (US)

Correspondence Address: CENTRAL COAST PATENT AGENCY, PO BOX 187, AROMAS, CA, 95004, US

(21) Appl. No.: 09/872,075

(22) Filed: Jun. 1, 2001

Related U.S. Application Data
(63) Continuation-in-part of application No. 09/757,553, filed on Jan. 9, 2001.
(63) Continuation-in-part of application No. 09/323,598, filed on Jun. 1, 1999, now Pat. No. 6,199,077.
(63) Continuation-in-part of application No. 09/208,740, filed on Dec. 8, 1998.
(60) Provisional application No. 60/279,254, filed on Mar. 27, 2001.

(51) Int. Cl. H04M 1/64

(52) U.S. Cl. 379/88.17

(57) ABSTRACT

A network-based hardware/software system for accessing, obtaining, and aggregating disparately sourced message data on behalf of requesting users is provided. The system comprises, a first server connected to the network for accessing targeted HTTP sourced message data on behalf of the users, a second server connected to network for accessing targeted voice message data on behalf of the users, a data normalizing software application for receiving data obtained by the first and second servers and for normalizing the data into a common machine-readable language and a data repository accessible from first and second servers and from the data normalizing application, the data repository for storing data about the users, data about accessible data sources, and data aggregated for the users. A user subscribing to the system receives voice messaging reconstructed from the normalized data, the normalized data comprising aggregated voice-based and text-based messages originally obtained from the disparate data sources.

### CROSS-REFERENCE TO RELATED DOCUMENTS

The present application is converted from and claims priority to provisional patent application 60/279,254 filed on Mar. 27, 2001. The present application is also continuation in part (CIP) to a U.S. patent application Ser. No. 09/757,553 entitled “Method and Apparatus for Obtaining and Aggregating Off-line User Data for Re-packaging and Presentation to Users over a Data-Packet-Network” filed on Jan. 9, 2001, which is a CIP to a U.S. patent application Ser. No. 09/323,598 entitled “Method and Apparatus for Obtaining and Presenting Web Summaries to Users” filed on Jun. 6, 1999, which is a CIP to a patent application Ser. No. 09/208,740 entitled “Method and Apparatus for Providing and Maintaining a User-Interactive Portal System Accessible via Internet or other Switched-Packet-Network” filed on Dec. 8, 1998, the disclosure of all applications listed above are incorporated herein in there entirety herein by reference.

### FIELD OF THE INVENTION

The present invention is in the field of Internet navigation and computer telephony integration and pertains more particularly to a system architecture enabling flexible multi-network navigation and aggregation of voice/data on behalf of users.

### BACKGROUND OF THE INVENTION

The information network known as the World Wide Web (WWW), which is a subset of the well-known Internet, is arguably the most complete source of publicly accessible information available. Anyone with a suitable Internet appliance such as a personal computer with a standard Internet connection may access (go on-line) and navigate to information pages (termed web pages) stored on Internet-connected servers for the purpose of garnering information and initiating transactions with hosts of such servers and pages.

Many companies offer various subscription services accessible via the Internet. For example, many people now do their banking, stock trading, shopping, and so forth from the comfort of their own homes via Internet access. Typically, a user, through subscription, has access to personalized and secure WEB pages for such functions. By typing in a user name and a password or other personal identification code, a user may obtain information, initiate transactions, buy stock, and accomplish a myriad of other tasks.

One problem that is encountered by an individual who has several or many such subscriptions to Internet-brokered services is that there are invariably many passwords and/or log-in codes to be used. Often a same password or code cannot be used for every service, as the password or code may already be taken by another user. A user may not wish to supply a code unique to the user such as perhaps a social security number because of security issues, including quality of security, that may vary from service to service. Additionally, many users at their own volition may choose different passwords for different sites so as to have increased security, which in fact also increases the number of passwords a user may have.

Another issue that can plague a user who has many passworded subscriptions is the fact that they must bookmark many WEB pages in a computer cache so that they may quickly find and access the various services. For example, in order to reserve and pay for airline travel, a user must connect to the Internet, go to his/her book-marks file and select an airline page. The user then has to enter a user name and password, and follow on-screen instructions once the page is delivered. If the user wishes to purchase tickets from the WEB site, and wishes to transfer funds from an on-line banking service, the user must also look for and select the personal bank or account page to initiate a funds transfer for the tickets. Different user names and passwords may be required to access these other pages, and things get quite complicated.

Although this preceding example is merely exemplary, it is generally known that much work related to finding WEB pages, logging in with passwords, and the like is required to successfully do business on the WEB. A service known to the inventor provides a WEB service that allows a user to store all of his password protected pages in one location such that browsing and garnering information from them is much simplified. A feature of the above service allows a user to program certain tasks into the system such that requested tasks are executed by an agent (software) based on user instruction. The service stores user password and login information and uses the information to login to the user's online sites, thus enabling the user to navigate without having to manually input log-in or password codes to gain access to the links.

The system described above includes further enhancements taught in reference Ser. No. 09/323,598 listed above in the cross-reference section. The enhanced portal server includes a software agent configured to do summary searches for subscribers based on Internet destinations provided by the subscribers. The software agent can retrieve information from such destinations based on pre-programmed site information and can download the summary information to the subscriber. The destinations and the nature of the information to be retrieved is pre-programmed. There is further a configuration and initiation interface for a subscriber to set up and start a summary search. In some cases the summary searches are configured for individual clients as templates stored and retrieved at the Internet-connected server. Also in some cases retrieved information is immediately sent to the subscriber, and in other situations such information is saved at the portal to be retrieved by a subscriber at a later time. In preferred embodiments of the invention auto logins are accomplished for a subscriber at Internet destinations by use of pre-stored configuration information.

It has occurred to the inventor that a user may in some instances desire to obtain certain offline information through a single interface such as the portal server described above. Examples of such off-line data may include telephone messages, voice mail messages, pager messages, message service messages and so on.

A system known to the inventor and referenced as Ser. No. 09/757,553 in the cross-reference section above utilizes a data access and aggregation server for accessing and aggregating off-line message data for requesting users. The data access is performed on behalf of users from a server location point on a data-packet network. The data access and aggregation server includes at least one communication port for bi-directional data communication between the server and users accessing the server from remote access nodes having access to the DPN. The system also has at least one communication port for bi-directional communication between a server and remote communications systems operating and hosted on a telephone network. The system is connected to a data repository containing pertinent data about users, users service sites and locations, and a section for storing aggregated data. At least one processor is coupled to the system for storing server software and communication software and a software application for enabling automated out-bound dialing and interaction with remote IVR-driven communications systems.

In response to user requests, the server dials destination numbers supplied by the users and upon connection therewith inputs any access codes required to trigger data playback whereupon the server records the played data and renders the data available to the requesting users.

The capability described above is enabled in part by new network bridging techniques enabling calls to be converted between disparate networks. Using the service made available by the disclosed system, a user may have access to off-line data held in disparate locations through one portal interface.

It has occurred to the inventor that through further integration and innovation, a unique service may be provided that blends the capabilities of on-line data gathering with the capabilities of off-line data gathering in a way that enables user access to both voice (on-line and off-line) and text data (on-line and off-line) through a same interface accessible from any communications device capable of at least dialing a telephone number. This specification focuses on a preferred system architecture and software capability for enabling such an improved system.

### SUMMARY OF THE INVENTION

In a preferred embodiment of the present invention, a network-based hardware/software system is provided for accessing, obtaining, and aggregating disparately sourced message data on behalf of requesting users. The network-based hardware/software system comprises, a first server connected to the network for accessing targeted HTTP sourced message data on behalf of the users, a second server connected to network for accessing targeted voice message data on behalf of the users, a data normalizing software application for receiving data obtained by the first and second servers and for normalizing the data into a common machine-readable language and a data repository accessible from first and second servers and from the data normalizing application, the data repository for storing data about the users, data about accessible data sources, and data aggregated for the users. A user subscribing to the system receives voice messaging reconstructed from the normalized data, the normalized data comprising aggregated voice-based and text-based messages originally obtained from the disparate data sources.

In a preferred embodiment, the system is hosted on the Internet network. In one aspect, an XML parser is utilized by the first server for parsing the HTTP-sourced data messages for the target data. The XML parser is capable of parsing at least HTML, WML, HDML, CHTML/I-Mode and SGML. In this same aspect, the voice data messages accessed by the second server include at least IVR-driven messages hosted by third-party services and voice messages available from voice browser systems running voice XNL software. In one aspect, the data repository houses the data normalizing software application. The data normalizing application includes a data dissemination engine for reading parsed data before normalization. The data is normalized into voice XML that is reconstructed into voice using server-side speech objects.

In another aspect of the present invention, the system further comprises, a computer telephony server connected to the network for interfacing with subscribing clients and for reconstructing voice XML into audible speech that is rendered to requesting users. The computer telephony server uses text-to-speech software and voice browser software to construct synthesized speech from the normalized data and render it to users over a telephony or Web-based interface. In a preferred embodiment, the computer telephony server is capable of outbound dialing and accepting incoming calls. In this embodiment, outbound dialing capabilities include dialing into at least a public switched telephone network and into a wireless cellular network. In all aspects, the system is accessible from at least one of a POTS telephone, a cellular telephone, and a mobile computing device operating in wireless mode.

In another aspect of the present invention, a voice-message gathering server connected to a data packet network is provided. The gathering server is utilized for gathering voice data from disparate data sources on behalf of users. The server comprises, a computer telephony interface and software for dialing and connecting to telephony numbers and for excepting telephony calls, an instance of sound recorder software for recording voice messages, an instance of voice-based navigation software for interacting with Web-based voice data sources and an instance of interactive voice-response-software for interacting with telephony-based voice data sources. Upon access and connection to a voice data source, the gathering server leverages a requesting users authentication credentials and recorded voice credentials if required for the purpose of accessing and then recording voice messages on behalf of the user.

In a preferred embodiment, the data-packet-network is the Internet network. In one aspect, the voice messages are digital voice files. In another aspect, the voice messages are analog voice recordings.

In another aspect of the present invention, a method is provided for normalizing message data gathered from disparate data sources on behalf of a requesting user and reconstructing the normalized data into audible voice data for presentation over a network including connected networks to a user interface. The method comprises the steps of, (a) disseminating the gathered data and converting the data into a common machine readable language, (b) aggregating the normalized data into a common database, (c) accessing the normalized data from the database according to user instruction, (d) reconstructing the normalized data into synthesized speech, (e) establishing a communications link to the user for the purpose of data transfer and (f) rendering the reconstructed voice messaging to the user over the communication link.

In a preferred embodiment, some of the data sources are hosted on the Internet network and some of the data sources are accessible through a telephony network. In one aspect of the method in step (a), some of the data is recorded voice data and some of the data is text data. In this aspect, in step (a) the common language is XML-based. In a preferred aspect of the method in step (b), the normalized XML files contain references to speech objects within accompanying DTDs. In one aspect of the method in step (d), the synthesized speech is of the form of digital speech.

In one aspect of the method in step (e), the communications link includes a wireless cellular link established through a wireless network gateway connected to the Internet network. In another aspect, the communications link includes a wired telephony link established through a telephony-network bridge connected to the Internet network. In one aspect of the method in step (f), the user receives the voice messaging in the form of a digital voice file at the user end. In another aspect, the user receives the voice messaging in the form of an analog recording at the user end.

In still another aspect of the method, steps (b) and (c) are omitted in the case of a real-time user request during an established and existing communication link.

Now, through further integration and innovation, a service is provided that blends the capabilities of on-line data gathering with the capabilities of off-line data gathering in a way that enables user access to both voice (on-line and off-line) and text data (on-line and off-line) through a same interface accessible from any communications device capable of at least dialing a telephone number.

### BRIEF DESCRIPTION OF THE DRAWING FIGURES

FIG. 1 is an architectural overview of a communication network wherein off-line data is retrieved, aggregated, and rendered available to users according to an embodiment of the present invention.

FIG. 2 is a block diagram illustrating off-line data aggregation application of FIG. 1 according to an embodiment of the present invention FIG. 3 is a process flow diagram illustrating user and system steps for practicing the present invention according to an embodiment of the present invention.

FIG. 4 is an architectural overview of a voice/data aggregation system according to an embodiment of the present invention.

FIG. 5 is a flow chart illustrating system steps for obtaining data, normalizing data, and rendering data according to an embodiment of the present invention.

### DESCRIPTION OF THE PREFERRED EMBODIMENTS

According to a preferred embodiment of the present invention, the inventor provides a network-based system for obtaining and aggregating off-line data pertinent to users and makes the data available to such users in a usable form accessible through a single interface connected to the network. The method and apparatus of the present invention is practiced in various embodiments and is described in enabling detail below.

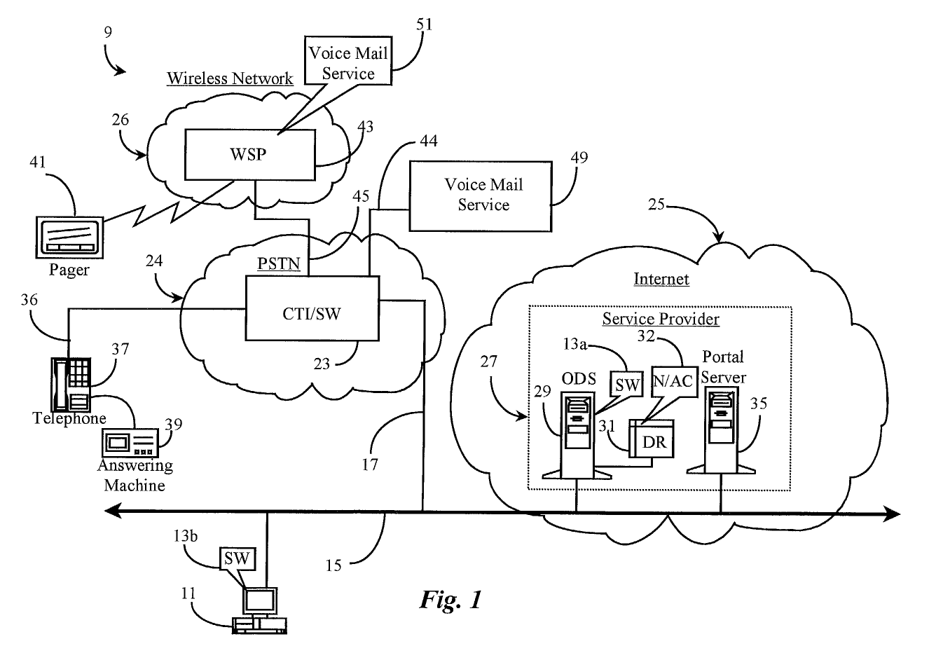

FIG. 1 is an architectural overview of a communication network 9 wherein off-line data is retrieved, aggregated, and rendered available to users according to an embodiment of the present invention. Communication network 9 comprises three separate and disparate but participatory networks. A data-packet-network 25, which is the Internet network in this example and hereinafter referred to as Internet 25, is illustrated as one of the three participatory networks. A telephony network 24, which is a well-known public-switched-telephony-network (PSTN) in this example and hereinafter referred to as PSTN 24 is illustrated as another. A cellular network 26 is illustrated as the third participatory network in this embodiment.

It should be understood that networks 26, 25, and 24 are exemplary, and not limiting to the invention. For example, Internet 25 may be instead a wide-area-network (WAN), either corporate or private. PSTN 24 may instead be a private telephony network. Wireless network 26 may be any type of wireless communication network using cellular, or other wireless communications technologies. The inventor chooses networks 25-26 in combination to form communication network 9 as a preferred example of a communications network wherein the present invention may be practiced.

Internet network 25 is further exemplified by an Internet backbone 15 illustrated herein as extending therethrough. Backbone 15 represents all of the lines, equipment, and connection points making up the Internet network as a whole including any sub-networks connected thereto. Therefore there are no geographic limitations to the practice of the present invention. Similarly speaking, PSTN 24 represents all the lines connection points and equipment making up the PSTN network as a whole including other accessible telephony networks that may be connected thereto. Wireless network 26 represents all accessible cellular areas or other wireless communications boundaries accessible through PSTN 24.

A service provider 27 is illustrated within Internet 25 and adapted to provide data-aggregation and summary services to users as described in cross-referenced document Ser. No. 09/323,598. However, this specification will focus on a novel capability of providing a service wherein off-line data may be accessed, aggregated, and presented to users. In this example a portal server 35 is provided within service provider 27 and connected to backbone 15. Server 35 is adapted as a user-interfacing server for providing access to services offered by provider 27 including aggregation of off-line data.

Server 35 serves electronic information pages, known as Web pages in the art, to requesting users accessing the server over backbone 15. An example of such a user is exemplified in this embodiment by a PC icon 11 illustrated as connected to backbone 15 by an Internet-access line 12. PC 11 represents any user's computer equipment capable of accessing server 35 through Internet backbone 15. It may be assumed in this example that PC 11 accesses server 35 by way of normal Internet connectivity means such as may be known in the art. Examples of possible Internet connection schemes include dial-up modem connection through an Internet-service-provider (ISP) through PSTN 24, an integrated- services-digital-network (ISDN) line or digital-subscriber-line (DSL), cable/modem technology, and through various wireless connection technologies. There are many variant connection-architectures possible in the art, therefore Internet access line 12 is intended solely to logically represent an Internet connection.

Portal server 35 is adapted to serve personalized portal pages to requesting users as described in both cross-referenced documents Ser. No. 09/208,740 and Ser. No. 09/323,598, wherein interactive input mechanisms are provided for ordering various data summarization services. In this example, users may access portal server 35 for the purpose of ordering a data summary representing a compilation of off-line data messages held at various off-line locations. The term off-line as used in this specification refers to any user-subscribed data sources that are accessible by telephone or other communication mode, but do not have an Internet presence. Such data may represent standard telephone messages, cellular phone messages, pager messages, voice mail messages, and any other types of recorded, typically electronic entities that may be normally accessible by dialing a connection-oriented-switched-telephony (COST) telephone number.

An outbound dialing server (ODS) 29 is provided within service provider 27 and illustrated as connected to Internet backbone 15. ODS 29 is adapted as an automated outbound dialing system capable of accessing COST telephone numbers. A data repository (DR) 31 is provided and illustrated as connected to ODS 29 by virtue of a high-speed data link. Data repository 31 is adapted to hold profile and practical data about users who subscribe to on-line and off-line data aggregation services provided by service provider 27. Examples of the types of data held in repository 31 include, but are not limited to, contact information, identification information, account information, and certain profile data.

An instance of software (SW) 13 (b, a) is provided as a client/server application with one part distributed to ODS 29 (13a) and another part distributed to PC 11 (13b). SW 13b at PC 11 may, in one embodiment, be a browser plug-in adapted to communicate data to SW 13a running on ODS 29. In this case, portal server 35 simply redirects users to server 29 for requested off-line data aggregation services. Re-direction may be accomplished by hyper-linking from a personal interface served by server 35 to an electronic interface (not shown) provided in server 29. It is noted herein, that data repository 31 contains, in addition to user identification and contact parameters, user supplied telephone numbers and access codes (N/AC 32) for enabling server 29 to obtain associated off-line message data using outbound dialing technology.

Off-line message data for a user is illustrated as available from a variety of sources illustrated in this embodiment. Wireless network 26 contains a wireless service provider (WSP) 43. WSP 43 provides wireless services to users operating wireless communications devices. One such device illustrated in this embodiment is a pager 41. Pager 41 is a two-way pager in this example. WSP 43 may also provide services to other types of devices such as a cellular telephone or a fixed wireless telephone. In this example, WSP provides a voice mail service 51 enabling a user of pager 41 to retrieve voice mails held at the service location.

A computer-telephony-integrated switch (CTI/SW) 23 is illustrated within PSTN 24 and adapted as a telephone call routing and switching point within the network. CTI/SW 23 may be any type of telephony switch known in the art such as an automatic call distributor (ACD), or other known equipment. Off-line message locations accessible through CTI/SW 23 include an illustrated telephone 37 connected to an answering machine 39. Telephone 37 is connected to CTI/SW 23 by way of a telephone line 36. Answering machine 39 is adapted to hold voice messages left for a user or users of telephone 37. A voice message service 49 is illustrated in this example and represents an entity providing a voice mail service for users. Service 49 is connected to switch 23 by virtue of telephony trunk 44. An example of service 49 would be that of a live-operator answering service for a business. It is noted herein that CTI/SW 23 is connected to WSP 43 by a telephony trunk 45. Therefore, all of the off-line data sources illustrated in this embodiment are accessible in this example through PSTN 24 and a CTI/SW 23. In another embodiment, disparate off-line data sources may be accessible by varied network paths and not necessarily through a single network switch (23).

CTI/SW 23 is connected to Internet backbone 15 by a network access line 17. It is noted herein but not illustrated that a network gateway adapted for bridging PSTN 24 to Internet 25 is assumed to be present somewhere along network access line 17 in order to enable cross communication between the networks. Such capability is known the art and described in the background section.

It is assumed in this example that a user operating PC 11 is a same user identified as a receiver of off-line message data held in answering machine 39, at voice message service 49, and at WSP 43 by virtue of voice mail service 51. In a prior-art scenario, the user operating PC 11 must either through PC 11 and an IP phone software, or through a telephone (not shown), dial-up each telephone number associated with each off-line message source and enter appropriate access codes by touch tone or voice means in order to remotely retrieve his or her messages.

In practice of the present invention, a user operating PC 11 accesses portal server 35 via an Internet-access technology as described above, and receives a personal portal page. By invoking a hyperlink provided within the served portal page, the off-line data aggregation service of the present invention hosted, in this example, within server 29 is accessed. Server 29 is now the interfacing server communicating with PC 11. Once connected to ODS 29, a request may be initiated from PC 11 for collection, aggregation, and presentation of off-line data. Upon receiving a request from a user operating PC 11, ODS 29 accesses data repository 31 to obtain the appropriate telephone numbers and access codes (32) that will be used to enable processing of the request. ODS 29, by virtue of SW 13a, places outbound calls to the appropriate telephone numbers associated with the off-line data sources. Once connected to a telephone number representing an off-line data source, the appropriate access code is used to invoke audio playback of stored messages. A recording function (not shown) attributed to SW 13a records message data during playback and stores the data on behalf of the requesting user in data repository 31. After a request is completely processed, the requesting user may access all off-line messages through a single interface during the same transaction. Aggregated message data may be temporarily held in data repository 31 or in any other connected repository accessible to ODS 29 for to portal server 35.

In one embodiment of the present invention request for retrieving off-line data and rendering it available may be real-time requests wherein the process is conducted while the requesting user is still in session (PC 11 to ODS 29) as described above. In another embodiment of the present invention requests may be pre-configured to execute on a periodic basis whether or not the requesting user is physically connected to the service. In the latter case, a user operating PC 11 may be notified of available messages at the time of login to portal server 35.

Rendering of off-line data into a form that may be transmitted to PC 11 may be accomplished using analog to digital conversion technologies. Voice data can, for example, be obtained and converted into a WAV or other known digital file format that is downloadable to PC 11. In one embodiment, voice messages, whether analog or digital, may be recorded and converted to text messages using voice to text software. There are many possibilities. The service of the present invention enables a user operating PC 11 or another Internet-capable device to retrieve off-line data from disparate sources through a single user interface during one transaction.

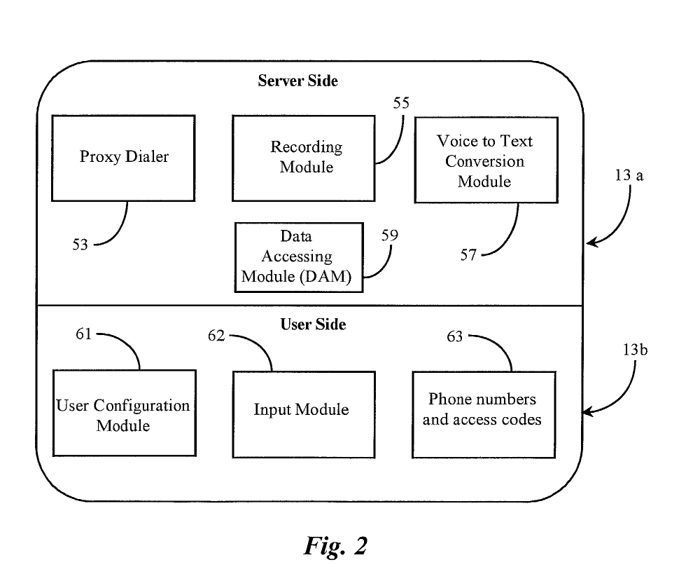

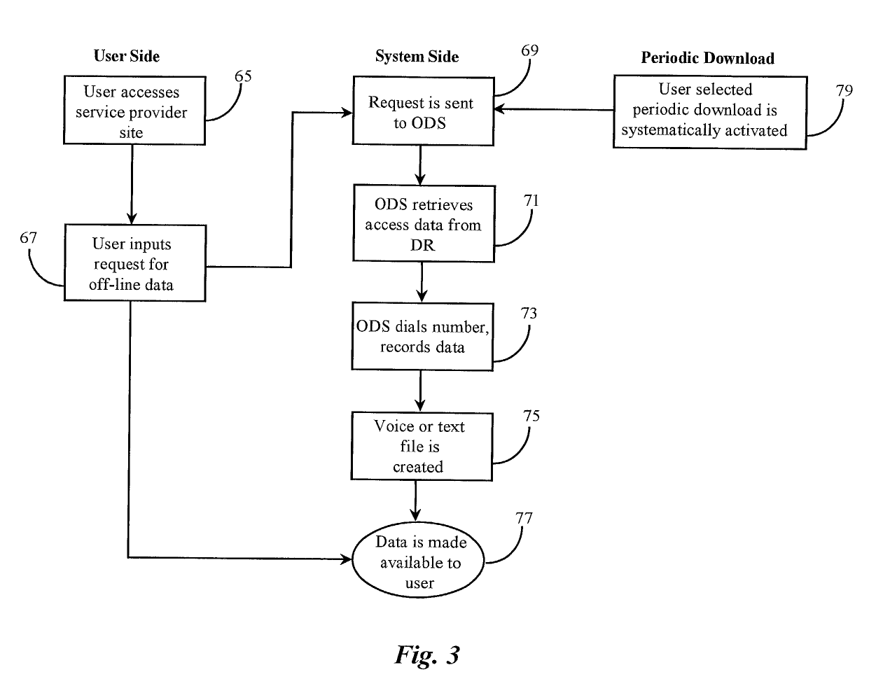

FIG. 2 is a block diagram illustrating off-line data aggregation application 13 (a, b) of FIG. 1 according to an embodiment of the present invention. Server side application 13 a, illustrated as executing on server 29 of FIG. 1 above, comprises a plurality of functional modules in this embodiment. A proxy dialer 53 is provided within application 13a and represents an IP telephone application capable of automated outbound dialing using user-supplied telephone numbers as data input. Proxy dialer 53 may also include a function enabling automated interaction with an interactive-voice-response (IVR) system. For example, after dialing a number and connecting to the associated destination, voice recognition software may be utilized to understand IVR instruction regarding entering an access code in order to retrieve specific messages. In some embodiments, an appropriate access code for retrieving messages is automatically entered by proxy dialer 53 after connecting to a destination service. In other embodiments dialer 53 may wait for an IVR voice prompt before entering a code. These types of parameters or rules-for-access may be preprogrammed with specific telephone numbers and access codes supplied by users.

SW 13a accesses telephone numbers and access codes from data repository 31 described in FIG. 1. A data-accessing module (DAM) 59 is provided for this purpose. A single user request may embody one, more than one, or all of the user's telephone numbers and access codes. In a real time service embodiment, SW 13a accesses only the required numbers and access codes to fill a particular request. It is assumed that in a periodic service environment that all provided numbers and access codes would be utilized during a data-retrieval and store scenario that would be performed perhaps once per day on behalf of all requesting users. However any combination of services may be configured by a requesting user.

A recording module 55 is provided within SW 13a and adapted to record voice messages as they are played during connection with a data source. Module 55 may be programmed to start and stop based on instruction from proxy dialer 53. Recording module 55 may record according to any desired digital format known the art. A voiced to text conversion module 57 is provided as an optional module within SW 13a. Module 57 uses voice to text technology to convert a record voice message into a text message.

User-side application 13b, illustrated on PC 11 of FIG. 1 provides a user configuration interface for pre-configuring parameters and communicating and updating telephone numbers and access codes. A user configuration module 61 is provided to enable a user to input telephone numbers and access codes for destinations having message data for access as well as to input known rules for accessing data. Module 61 also enables a user to pre-configure requests designed to be executed periodically. An input module 62 enables a user to configure real-time requests to be executed while a user is connected in session with ODS 29 of FIG. 1. A module 63 is provided for keeping a current user list of telephone numbers and access codes stored in user cache. Communication modules (none shown) may be assumed to be present for enabling data communication between application 13a and 13b.

In one embodiment of the present invention, SW applications 13a and 13b are provided as a single application running on ODS 29 of FIG. 1. In another embodiment, the software may be provided on any other server designated as an interfacing server. The method of user interface is in preferred embodiments, an HTML interface displayable on such as PC 11, however other technologies may be employed for other types of access devices. For example, a scaled-down version (Web clipping) of interfacing media may be provided for Web-enabled cell phones, hand-held computers, and other Internet-capable accessing devices.

In addition to access and aggregation of personalized message data, the method and apparatus of the present invention may be used to access and aggregate publicly accessible data. Examples include but are not limited to recorded movie listings, traffic and weather alerts, emergency instruction data, and virtually any other type of recorded data accessible by telephone.

It will be apparent to one with skill in the art, that there may be more software modules illustrated in application 13 (a, b) than are illustrated in this example without departing from the spirit and scope of the present invention. For example, application program interface (API) modules may exist for interfacing with supporting software programs providing functions such as voice recognition, voiced to text conversion, instruction software containing access an interaction rules for dialing and interacting with destination equipment, and so on.

FIG. 3 is a process flow diagram illustrating user and system steps for practicing the present invention according to an embodiment of the present invention. At step 65, a user accesses a web site maintained by a service provider, which is accomplished in the example illustrated in FIG. 1 by first accessing portal server 35 and being redirected to outbound dialing system and server 29. It is noted herein that access may be accomplished using any Internet-capable device having sufficient input functionality and display means. At step 67, the requesting user inputs information forming a data request for receiving off-line data. Step 67 represents an example wherein the requesting user initiates a sequence while physically connected to the providing server (ODS 29).

In an embodiment wherein the off-line data is systematically aggregated, steps 79 illustrated under the heading periodic download, is performed on an ongoing basis at a frequency determined by the service provider. In this case at any pre-configured time steps 69-77 are automatically executed as a sequence using data pre-supplied by the requesting user. Such a sequence occurs in the background and is transparent to requesting user. If at step 67, the requesting user desires to initiate an impromptu sequence or “refresh”, then at step 69 the requested sent to the outbound dialing server illustrated in FIG. 1 has ODS 29.

At step 71, the outbound dialing server retrieves access data comprising telephone numbers and access codes identified in request of step 67 from a connected data repository illustrated in FIG. 1 as DR 31. At step 73, the outbound dialing server begins a sequence of automated dialing, connection, entry of access code, and recording of message data. Step 73 is repeated as a process for each access telephone number identified in a single request. At step 75, voice or text versions of the recorded data are formatted for presentation to the requesting user. Voice data may be reformatted according to a WAV format or other known digital formats. Optionally, text renditions of the recorded data may be provided using suitable voice to text software. In the latter case, text versions of recorded messages may only be summaries of the content contained in each represented message. At step 77, the formatted data is made available to the requesting user in the form of a download that may be presented according to a push or pull scenario based on the desire of the requesting user.

It will be apparent to one with skill in the art that the user and system process steps illustrated in this example represent just one of a variety of possible sequences that may be employed and implemented for practicing the present invention. Other steps to be included in an automated sequence according to variant embodiments of the invention. For example, in one embodiment step 75 would not be required to access device is capable of playing digital voice files. In another embodiment, data obtained aggregated and formatted for a user may be delivered to a node or access device other than the one initiating a request. There are many variant possibilities.

The method and apparatus of the present invention may be practiced on any data-packet-network that may be bridged to any telephone network having routed access to the destination numbers of a request.

### Multi-Network Voice/Data Gathering, Aggregation and Presentation System

In one aspect of the present invention, a voice/data aggregation system is provided for gathering voice/data from on-line or off-line sites and presenting the data to requesting users in all voice, voice and text, or all text to any suitable user-employed accessing device.

Referring now to FIG. 1 of Ser. No. 09/757,553, a system is provided for obtaining and aggregating off-line voice data that can be presented to a user over a single user-interface. System 9 as illustrated is fairly inflexible in terms of the varying types of data that can exist and be converted to voice data on behalf of a user. In this example, only off-line data is represented. However, it is desired that all of a user's data sources, including any public data sources, be accessible for the purpose of obtaining data that may be vocalized to a user over an audio interface.

Recent developments in the capability of converting text to speech have enabled a fully integrated engine, in the broad sense, that can obtain, aggregate and render virtually any data source as voice, a combination of text and voice, or as simply text data over a single interface to a requesting user. Such an Integrated system and software is illustrated below.

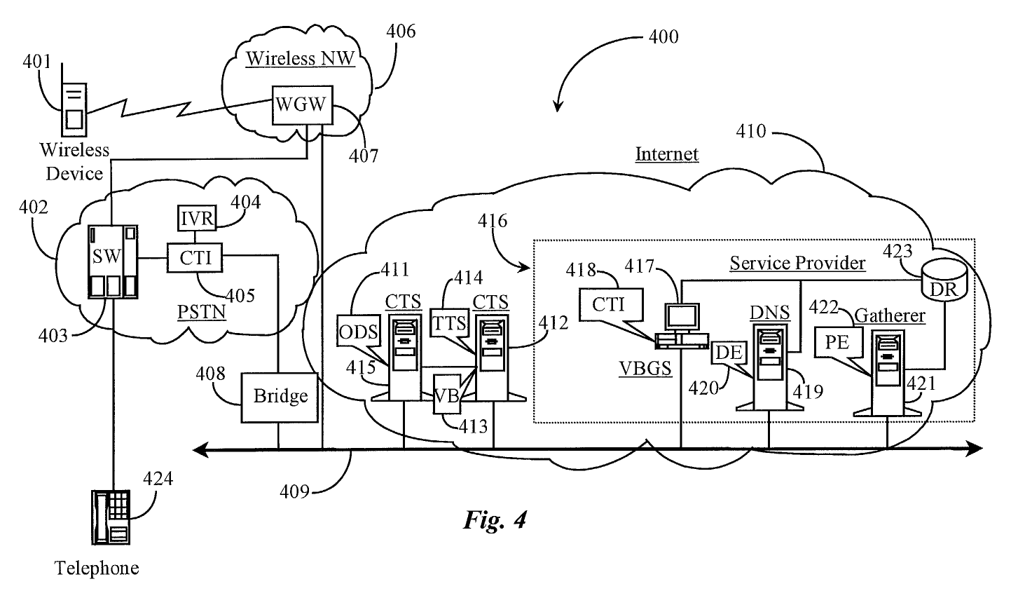

FIG. 4 is an architectural overview of a voice aggregation system 400 according to an embodiment of the present invention. Voice aggregation system 400 utilizes 3 basic communications networks to enable its goals. These are a telephony network 402, a wireless network 406, and a data-packet-network (DPN) 410. Network 402 is, in a preferred embodiment, the well-known public-switched-telephony-network (PSTN) as is so labeled. Network 406 may be any wireless data network that is accessible from a wireless communication device. An example would be that of a cellular telephone network. Network 406 includes all types of known networks accessible by a wireless phone, or other mobile appliances. DPN 410 is, in this example, the well-known Internet network as so labeled. However, network 410 may be a private or corporate wide-area-network (WAN) or any other type of digital data network.

Networks 410 (Internet), 402 (PSTN), and 406 (Wireless) are chosen for this example because of their integration capacity with each other and because of their high public-access characteristics. It is these networks and associated providers that typically provide telephone or digital access to data maintained on behalf of users at various locations. For example, data sources on the Internet network include text data as well as digital voice data. Sources accessible through the wireless network or the PSTN network include traditional IVR-driven message services, user-maintained voice messages (local answering systems), and publicly accessible voice data (maintained by third parties).

Internet 410 is further exemplified herein by an Internet backbone 409 extending therethrough. Backbone 409 represents all of the equipment, lines and connection points that make up the Internet network as a whole. Therefore there are no geographic limits to the practice of the present invention. Similarly, networks 406 and 402 enjoy a wide regional architecture.

System 400 is provided and enabled by a service provider 416 illustrated in this example as encompassed by a dotted rectangle labeled Service Provider. Service provider 416 offers a novel data aggregation and rendering service that, in preferred embodiments, may be accessed from a mobile network-access appliance. However, any means of data access is compatible in this embodiment. In this example, service provider 416 is illustrated within the domain of Internet 410. This simply implies that equipment illustrated therein has Internet-connect capability thus including provider 416 within the domain of the Internet. The physical representation of provider 416 within Internet cloud 410 is logical only.

Two communications appliances are illustrated in this example as having access to system 400. These are appliance 401, a wireless telephone, and a normal plain-old-telephony-service (POTS) telephone 424. Both communications appliances 401 and 424 illustrated in this example are assumed to be owned and operated by a same user for the purpose of accessing data aggregated by service provider 416. Additional communications devices that may be used to access system 400 include but are not limited to wireless mobile devices installed in automobiles, wireless hand-held computers, lap top computers, and personal computers wired to the Internet.

Inside the realm of service provider 416 there are a variety of illustrated servers providing separate and dedicated functions. A gatherer system sever 421 is provided within the domain of provider 416 and adapted to obtain a user's Web-based data via automated Web navigation as disclosed in copending application Ser. No. 09/323,598. A parsing engine identified herein as PE 422 is utilized to disseminate target data for aggregation. Gathering system server 421 is illustrated as connected to backbone 409 in this example.

A voice-based gathering system (VBGS) 417 is provided within the realm of provider 416, and is adapted by computer telephony integration (CTI) software 418, and hardware (not shown) for the purpose of obtaining voice-based data from any sources accessible through networks 410, 402, or 406. VB GS is illustrated as a computer icon in this example, instead of a server icon because of a fact that it is formed of a computer and CTI hardware/software in actual practice. Server 417 is capable of out-bound dialing into PSTN 402. Server 417 is illustrated herein as connected to backbone 409.

A data-normalizing server (DNS) 419 is provided within the realm of provider 416 and is adapted to normalize data obtained by servers 421 and 417 into a common data format. Server 419 uses a data dissemination engine (DE) 420 for the purpose of reconstructing normalized data into synthesized speech. DNS server 419 is illustrated as connected to backbone 409 as are the other described servers.

Servers 417, 419, and 421 share a common data repository (DR) 423, which is adapted to warehouse data attributed to users of the system and data obtained and aggregated by the system on behalf of the users. DR 423 may be any type of digital data storage system capable of mass data storage. Disk storage, or other known data storage technologies may be used. It is assumed in this example, that DR 423 has the appropriate database software installed thereon for organizing and processing data as well as the appropriate application program interfaces to other connected servers.

In one embodiment, DNS 419 and DE 420 are actually part of DR 423. However, the inventor chooses to illustrate the just-described components separately in order to illustrate dedicated function. In fact, all of the components illustrated within provider 416 may be provided in the form of one powerful software-enabled server. Logical separation of the functions in this example aids in description of the novel architecture of the present invention.

Two computer telephony servers (CTS) 412 and 415 are provided within the realm of network 410 and are adapted to cooperate with one another in order to provide a customer access point into system 400 as well as a customer voice-based dispatch service. In one embodiment CTS servers 415 and 412 may be combined within one physical machine enabled by software. CTS 412, in this example, functions as a user access point and is adapted by way of software with the capabilities of accepting voice calls sourced from networks 402, 401, and 410, as well as performing user authentication functions. CTS 412 has a voice browser software (VB) 413 installed therein and adapted to understand voice calls and utilize the information. In some embodiments, CTS 412 using VB 413 may authenticate users by voice-print, analogous to fingerprint. CTS 412 also has a text-to-speech (TTS) application 414 installed therein and adapted for converting text data into speech.

CTS 415 is adapted with outbound dialing capability illustrated herein by outbound dialing software (ODS) 411 installed therein. CTS 415 may dial out over network 410 and into PSTN 402 through network bridge 408. Through combining the functions of server 412 and 415, either active or passive interface may be achieved between a user and system 400. In an active mode, a user connecting to system 400 through a device analogous to devices 401 or 424 may actively request certain types of data information for instant real-time delivery. In a passive mode, a user is delivered pre-designated data information at pre-designated times or at the time of occurrence of pre-designated events without the user having to make an active request.

Referring now to PSTN 402, a CTI-enabled telephony switch (SW) 403 is illustrated and adapted as a call processing and switching apparatus such as an automatic call distributor (ACD) or a private branch exchange (PBX) switch. SW 403 may be any type of known telephony switch capable of processing and routing telephone calls. CTI capability is illustrated herein by a CTI processor 405 connected to SW 403 by a CTI link. Processor 405 is adapted to provide intelligent call processing capability to an otherwise relatively dumb SW 403. Part of CTI capability includes an interactive voice response unit (IVR) 404 logically illustrated as connected to processor 405. IVR 404 is adapted to interface with callers connecting to switch 403. Third-party services providing voice-based information to the public or to subscribing users may interact with callers at the point of SW 403. Similarly, SW 403 may be hosted as a customer access point to voice-based services such as tele-banking services, for example, whose access may be enabled using voice or touch-tone technologies through the IVR functionality.

Referring now to wireless network (NW) 406, a wireless gateway (WGW) 407 is illustrated within the realm of NW 406 and is adapted to enable transfer of user-originated wireless transmissions from NW 406 into PSTN 402 by bridging techniques known in the art. A telephony line physically connecting WGW 407 to SW 403 within network 406 illustrates connection from WGW 407 to PSTN 402. WGW 407 is also illustrated as connected to backbone 409 within the realm of network 410. Wireless users may therefore access wireless Web sites over the just described connection provided that access capability to network 410 is included within the device used for access. Web sites accessible from network 406 are constructed using wireless markup language (WML) or other suitable mark-up languages compatible to wireless access protocol (WAP)-enabled devices. Device 401 could, for example, be an Internet-capable cellular telephone capable of accessing either PSTN 402 or Internet network 410. It is important to note herein that WGW 407 may be hosted by a single wireless service provider or shared by more than one provider.

It is important to note herein that the physical representation in this example of interconnected architecture residing in networks 406, 402 and 410 is meant to show integrated communication capabilities that exist between the networks. One with skill in the art of network architecture will readily appreciate that there are several varying types of gateways and other equipment that can be used to integrate the described networks for cross-communication. One with skill in the art will also appreciate that in the prior-art sense, a user may access any of his or her voice-based services or other data services hosted in any of the networks directly through use of suitable communications devices, however the novel architecture and software combination of the present invention illustrated, in this example, within the domain of network 410, enables a user to leverage all accessible services using a single authentication through just one of the described user-access devices.

In the case of an active interface wherein a requesting user initiates a request which is processed while he or she is still connected, the user accesses system 400 using, in this example, one of devices 424 or 401 and instructs the system which specific data source or sources to access. For example, a user operating wireless device 401 may initiate a call to CTS 412 of system 400 for the purpose of requesting a data rendering. There are two paths through which the user may connect. The most obvious is through WGW 407 within network 406, onto backbone 409 and to CTS 412. A less obvious path is from WGW 407 to SW 403, through bridge 408 and on to CTS 412.

VB software 413 enables system dissemination of the user's voice request as well as authentication of the user using voice fingerprint technology at the time of connection. A speech-to-text software application (not shown) may be provided within CTS 412 and adapted to convert a voice request into a system readable language such as Extended mark-up language (XML), which in a preferred embodiment of the present invention, is the normalized language utilized by the system for internal processing of data. A speech-to-text capability may be built into VB 413. In one embodiment, CTS 412 may also take a text-based request from the user operating device 401 although this is not preferred because of the limited data input capability (no keyboard) of device 401.

Internal request processing depends upon the nature and location of the data sources requested. If the user, for example, requests data from an HTTP source, the request is sent over backbone 409 to server 421 which performs Web-based gathering. Server 421 navigates to the source and parses the source for the requested data using PE 422. DNS 419 then normalizes the parsed data using DE 420. In a preferred embodiment, all data, whether voice or text, is normalized into XML. If the data source is voice it is normalized into voice-based XML wherein speech objects are contained in the document-type-definitions (DTD) accompanying the normalized data so that voice reconstruction may be readily accomplished.

Data normalized by DNS 419 is stored on behalf of the user in DR 423 if the user requests that the information be accessible at a time later than the requesting session. Otherwise, it is pushed in normalized form back to CTS 412 wherein TTS 414 is used to render the data as computer synthesized speech. If the user is still in session with CTS 412, the message data is played for the user as speech. If the user has requested a call back from system 400, then CTS 415 dials the user's device using ODS 411 and the message data rendered as speech is played when the user picks up. In one embodiment, the data may be played on an answering device if authorized.

If the request from the user described above involves voice-based data, then the original request is sent to VBGS 417 instead of server 421. VBGS 417 utilizes CTI capability to dial the number (or invoke a URL) of the requested data source. VBGS uses supplied authentication information from the user to access the data source. VBGS may interact with IVR 404 on behalf of a user, or with any other voice-based service accessible through any of the illustrated networks. Upon connecting to the requested source and authenticating the user, VBGS records the voice data from the source and sends the recordings to DNS 419 where it is normalized as previously described. CTS 412 and 415 perform their respective functions also as previously described.

It is possible that voice-based sources are recorded and then played directly for the user without data normalization if the instant software/hardware format of the user's device allows. However, in most cases, it is preferred that voice data is normalized and then reconstructed to ensure a common presentation format and quality of voice during presentation to the user. Likewise, one request may contain a variety of voice-based data sources wherein the voice formats for audible presentation are different.

It is noted herein that one user request may contain data sources wherein the original data is presented as both text and voice-based data. In this case the request fulfillment responsibility is shared among servers 421 and 417 appropriately. It is also noted that servers 415 and 412 may be separate third-party services already established and leveraged by system 400 to provide user interface and message delivery. Services that could host the function of server 412 include, but are not limited to TellMe™, and BeVocal™, both well-known services. The functions of server 415 could be hosted by a third-party service such as Envoy Worldwide™ or, perhaps, Adeptra™. There are many possibilities.

In case of a passive use of system 400, both VBGS 417 and gathering server 421 poll data sources defined by a user with respect to an ongoing service configuration initiated at some point by the user. In one embodiment, data sources can notify system 400 when new data events occur. When any data source indigenous to the particular user is updated the appropriate gathering server (417 if voice, 421 if text-based) navigates to and interacts with the site to obtain the data in the same fashions as previously described. The gathered data is then normalized by DNS 419 and stored in DR 423 in place of the older data from the same source or sources. At a pre-designated time, CTS 412 retrieves the updated data from DR 423 and reconstructs the data into audible speech. CTS 411 then dials the user or a system of the user and delivers the audible messaging at pickup of the call. In one embodiment, the subscribing user calls CTS 412 for an update and receives the audible messaging while connected in session.

It is noted herein that preferred applications of system 400 enable audible rendering of the data to a user accessing from any communications device capable of receiving and playing the audio data whether it be POTS telephone, cellular telephone, PC speaker system, mobile device speaker system and so on. It should be noted however that the data might also be presented as a combination of audible messaging and text messaging, or in all text.

The architecture comprising system 400 as a whole presents a flexible implementation of data gathering capabilities of servers 421 and 417, which is not available in current art. Furthermore, application of XML technology for the purpose of normalizing a variety of data formats into a common format that can be reconstructed into a high quality voice format provides an enhancement to current art voice-based dispatch services represented in this example by CTS 415. Voice formats that normalized data is reconstructed to include, but are not limited to analog, wav, mp3, wireless digital, and ram. Data presented in formats such as HTML, SGML, WML, HDML, C-HTML, or other known SGML/XML based mark-up languages may be parsed and normalized into a voice-based XML format.

The method and apparatus of the present invention may be practiced in a variety of embodiments and situations using different access devices, receiving audible messaging in varied formats, accessing from differing networks, and so on. The goal of enabling a user to receive audible data from virtually any network-accessible data source through a single accessing device is accomplished by the novel interaction and architecture of components 421, 419, and 417 including software capabilities.

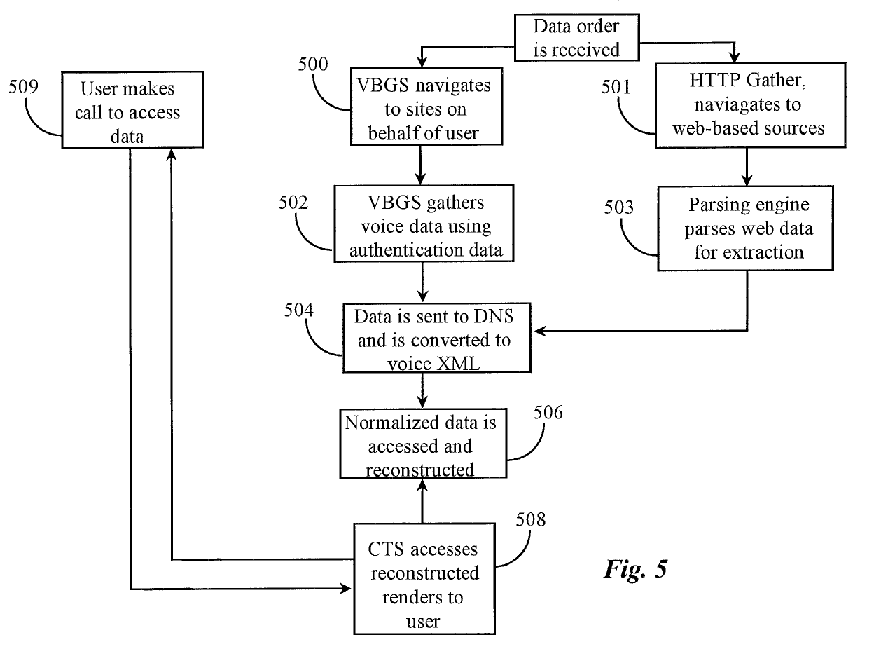

FIG. 5 is a flow chart illustrating system steps for obtaining data, normalizing data, and rendering data according to an embodiment of the present invention. In this example, the flow chart comprises two main processes performed by key architectural components. A voice-based pathway is illustrated on the left side, and an on-line pathway is illustrated on the right side of this exemplary process flow chart. It is noted herein that in the case of a pre-configured user request containing both Web-based and off-line data sources, both process pathways operate independently from one another and simultaneously in order to fulfill an order. It is assumed in this example that a user request precedes both of the pathways that will be described below as exemplified by a block labeled Data Order is Received.

At step 500, a voice based gathering system analogous to VBGS 417 of FIG. 4 navigates to off-line sites on behalf of the user. VBGS may also navigate to voice-based data sources held on-line such as on the Internet network. This step corresponds to the described activity of VBGS 417 (FIG. 4) within the realm of service provider 416 wherein VBGS 417 places outbound calls to third party IVR/voice portal systems on behalf of the user to obtain voice messages. VBGS may also place calls to Web sites containing interactive voice messaging.

At step 502, VBGS inputs the users required authentication credentials at each requested site and records the accessed voice data on behalf of the user. At step 502, authentication may include inputting user identification data such as PIN numbers or recorded voice credentials stored in a database analogous to DR 423 of FIG. 4. There are many possibilities. VBGS 417 gathers data from any off-line data sources in PSTN 402 or wireless NW 406. VBGS 417 also has the capability of gathering voice-based data from data sources in DPN 410.

At step 504, data gathered by VBGS is sent to a data-normalizing server analogous to DNS 419 of FIG. 4 and is converted to voice-based XML. In one embodiment step 504 is not necessary if the quality of voice recording is suitable for instant rendering to a requesting user without alteration. However, it may be that voice messages from disparate services will be of varying formats and therefore must be normalized and then reconstructed into a common format for presentation to a requesting user.

At step 506, data that is normalized is sent to a data repository for storage until such time that a user requests it or until such time as the data will be pushed to a user. The data repository described above is analogous to DR 423 of FIG. 4. In one embodiment wherein the user is waiting on-line (connected) for the data, step 506 may be bypassed.

At step 501, a user's Web-based sources are accessed by an HTTP-based gathering server analogous to server 421 of FIG. 4. In this step, the gatherer uses any required log-in and authentication credentials that may be required for access. At step 503, an XML parser parses Web data for extraction and the data is gathered.

Step 503 culminates into steps 504 and then 506 as is the case of data gathered by the VBGS. At step 509 then, a user calls a customer access server analogous to CTS 412 of FIG. 4 to receive rendered data. A user need only provide a single authentication credential at the time of access. In one embodiment, the user's device automatically calls and authenticates the user. In still another embodiment, voice-based authentication technologies might be used.

At step 508, CTS 412 described above and with reference to FIG. 4 accesses DR 423 described with reference to step 506 and retrieves the normalized data on behalf of the user. In this process example, normalized data originates from both Web-based and off-line sources. In this step the data is reconstructed using TTS software and speech objects defined in the XML DTDs of the normalized data files and rendered via voice dispatch or over the existing CTS connection to the user. It will be apparent to one with skill in the art that the process steps outlined in this example may vary somewhat in order as well as in number without departing from the spirit and scope of the present invention. Due to the flexible nature of the interaction of components and varied scenarios which may exist and define a specific user request, there are a variety process paths that may be envisioned and implemented without departing from the spirit and scope of the present invention. For example, if the user of step 509 does not have Web-based sources to include in his or her data request, then the functions of steps 501 and 503 would not apply. If the user only has Web-based sources to tap for data, then steps 500 and 502 would not apply.

One with skill in the art will recognize that the method and apparatus of the present invention provides considerable improvement over prior art methods and apparatus for enabling a multi-network voice/data gathering and aggregation system. For example, it allows a user to access information from a large variety of data sources without requiring the development of interfaces into numerous and separate databases. The present invention also enables a user to access data from numerous and separate data sources with a single authentication credential. Preferred embodiments of the present invention allow a user to access these data sources from wireless-enabled automobiles, analog and digital wireless telephones, and regular plain-old-telephone-service (POTS) telephone sets.

The method and apparatus of the present invention can encompass many variations of data gathering normalization and rendering. These variations may be customized according to user preference, accessing device, accessing network, user software/hardware capabilities, and so on. There are many variable embodiments. Therefore, the method and apparatus of the present invention should be afforded the broadest scope under examination. The spirit and scope of the present invention is limited only by the claims that follow.

What is claimed is:

1. A network-based hardware/software system for accessing, obtaining, and aggregating disparately sourced message data on behalf of requesting users comprising:
a first server connected to the network for accessing targeted HTTP sourced message data on behalf of the users;
a second server connected to network for accessing targeted voice message data on behalf of the users;
a data normalizing software application for receiving data obtained by the first and second servers and for normalizing the data into a common machine-readable language; and
a data repository accessible from first and second servers and from the data normalizing application, the data repository for storing data about the users, data about accessible data sources, and data aggregated for the users;
characterized in that a user subscribing to the system receives voice messaging reconstructed from the normalized data, the normalized data comprising aggregated voice-based and text-based messages originally obtained from the disparate data sources.

2. The system of claim 1 hosted on the Internet network.

3. The system of claim 1, wherein an XML parser is utilized by the first server for parsing the HTTP-sourced data messages for the target data.

4. The system of claim 3, wherein the XML parser is capable of parsing at least HTML, WML, HDML, CHTML/I-Mode and SGML.

5. The system of claim l,wherein the voice data messages accessed by the second server include at least IVR-driven messages hosted by third-party services and voice messages available from voice browser systems running voice XML software.

6. The system of claim 1, wherein the data repository houses the data normalizing software application.

7. The system of claim 1, wherein the data normalizing application includes a data dissemination engine for reading parsed data before normalization.

8. The system of claim 7, wherein the data is normalized into voice XML that is reconstructed into voice using server-side speech objects.

9. The system of claim 1, further comprising:
a computer telephony server connected to the network for interfacing with subscribing clients and for reconstructing voice XML into audible speech that is rendered to requesting users;
characterized in that the computer telephony server uses text-to-speech software and voice browser software to construct synthesized speech from the normalized data and render it to users over a telephony or Web-based interface.

10. The system of claim 9, wherein the computer telephony server is capable of outbound dialing and accepting incoming calls.

11. The system of claim 10, wherein outbound dialing capabilities include dialing into at least a public switched telephone network and into a wireless cellular network.

12. The system of claim 9 accessible from at least one of a POTS telephone, a cellular telephone, and a mobile computing device operating in wireless mode.

13. A voice-message gathering server connected to a data packet network, the gathering server for gathering voice data from disparate data sources on behalf of users comprising:
a computer telephony interface and software for dialing and connecting to telephony numbers and for excepting telephony calls;
an instance of sound recorder software for recording voice messages;
an instance of voice-based navigation software for interacting with Web-based voice data sources; and
an instance of interactive voice-response-software for interacting with telephony-based voice data sources;
characterized in that upon access and connection to a voice data source, the gathering server leverages a requesting users authentication credentials and recorded voice credentials if required for the purpose of accessing and then recording voice messages on behalf of the user.

14. The voice-message gathering server of claim 13, wherein the data-packet-network is the Internet network.

15. The voice-message gathering server of claim 13, wherein the voice messages are digital voice files.

16. The voice-message gathering server of claim 13, wherein the voice messages are analog voice recordings.

17. A method for normalizing message data gathered from disparate data sources on behalf of a requesting user and reconstructing the normalized data into audible voice data for presentation over a network including connected networks to a user interface comprising steps of:
(a) disseminating the gathered data and converting the data into a common machine readable language;
(b) aggregating the normalized data into a common database;
(c) accessing the normalized data from the database according to user instruction;
(d) reconstructing the normalized data into synthesized speech;
(e) establishing a communications link to the user for the purpose of data transfer; and
(f) rendering the reconstructed voice messaging to the user over the communication link.

18. The method of claim 17 wherein some of the data sources are hosted on the Internet network and some of the data sources are accessible through a telephony network.

19. The method of claim 17 wherein in step (a), some of the data is recorded voice data and some of the data is text data.

20. The method of claim 17 wherein in step (a), the common language is XML-based.

21. The method of claim 17 wherein in step (b), the normalized XML files contain references to speech objects within accompanying DTDs.

22. The method of claim 17 wherein in step (d), the synthesized speech is of the form of digital speech.

23. The method of claim 17 wherein in step (e), the communications link includes a wireless cellular link established through a wireless network gateway connected to the Internet network.

24. The method of claim 17 wherein in step (e), the communications link includes a wired telephony link established through a telephony-network bridge connected to the Internet network.

25. The method of claim 17 wherein in step (f), the user receives the voice messaging in the form of a digital voice file at the user end.

26. The method of claim 17 wherein in step (f), the user receives the voice messaging in the form of an analog recording at the user end.

27. The method of claim 17 wherein steps (b) and (c) are omitted in the case of a real-time user request of an established and existing communication link.
